(19) United States
(12) Patent Application Publication
(10) Pub. No.: US 2007/0170828 A1
(43) Pub. Date: Jul. 26, 2007

(54) Movable body driving device and automatic drawer equipment

(75) Inventors: Kaoru Hoshide, Tokyo (JP); Akira Sato, Tokyo (JP); Soichi Sasaki, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: THK CO,, LTD, Tokyo (JP)

(21) Appl. No.: 10/587,896

(22) PCT Filed: Jan. 26, 2005
(86) PCT No.: PCT/JP05/00992

§ 371 Date: Jul. 28, 2006

(30) Foreign Application Priority Data
Jan. 30, 2004 (JP) 2004-023792
Jan. 30, 2004 (JP) 2004-023793

(51) Int. Cl. A47B 88/00; E05F 15/14

(52) U.S. Cl. 312/319.5

(57) ABSTRACT

To provide a movable body driving device which has simple structure and is capable of moving a movable body in a certain direction and automatic drawer equipment. A movable body driving device is provided which comprises a roller 12 as a rotary member which is rotatably supported on an inner frame 11 as a supporting member and a motor 13 for rotating the roller 12. The roller 12 is brought in contact with the movable body, which is adapted to be movable in a certain direction, with predetermined force using elastic force of coil springs 21, 22, 23 as elastic members. The movable body is moved by frictional force between the movable body and the roller 12. Automatic drawer equipment employing the movable body driving device as its drawer driving mechanism is also provided.

### FIELD OF THE INVENTION

The present invention relates to a movable body driving device for driving a movable body, such as a door or a drawer which is movable in a certain direction, in the moving direction and automatic drawer equipment in which a movable body driving device is employed as its drawer driving mechanism.

### BACKGROUND OF THE INVENTION

As a method of driving a movable body, for example for reciprocating a door body of an automatic door system in certain directions to open and close the door, there are various driving methods such as a rack-and-pinion driving method, a wire driving method, a hydraulic driving method, and a linear-motor driving method. However, any of these has a problem that the mechanism thereof is complex so that troublesome adjustment among components is required and the cost is expensive. On the other hand, automatic drawer open-close operation has been conducted by a mechanical mechanism using an elastic member such as a spring or using guide rails which can be inclined. These have also a problem that the adjustment among components and the mechanism for inclining the rails are complex so that troublesome adjustment is required.

Conventionally, most of drawers of kitchen counters and furniture are of a type to be manually opened and closed. Therefore, it is impossible or quite difficult for a user to open or close a drawer when the user has something with his or her both hands. Further, in furniture, such as a kitchen counter, having multiple drawers accommodated in a frame body, heavy items are generally accommodated in the lowermost drawer. Accordingly, since a user must bow to take the heavy item in or out, it is hard work especially for a handicapped person or an elderly person to take the heavy item in or out.

There is a way to address this problem. That is, automatic drawer equipment can be structured such that a mechanical mechanism using an elastic member such as a spring or using guide rails which can be inclined is employed for achieving automatic opening and closing of a drawer. However, there is still a problem that the adjustment among components and the mechanism for inclining the rails are complex so that troublesome adjustment is required.

### SUMMARY OF THE INVENTION

### PROBLEMS TO BE RESOLVED BY THE INVENTION

The present invention has been made in view of the aforementioned problems and the first object of the present invention is to provide a movable body driving device which has simple structure, allows easy adjustment, and is capable of moving a movable body in a certain direction.

The second object of the present invention is to provide automatic drawer equipment which is capable of opening and closing a drawer just by providing a drawer driving mechanism with simple structure and which has premium quality.

### MEANS TO SOLVE THE PROBLEMS

To achieve the aforementioned first object, the present invention provides a movable body driving device comprising a rotary member rotatably supported on a supporting member and a driving means for rotating the rotary member, wherein the rotary member is engaged with a movable body, which is adapted to be movable in a certain direction, with predetermined force using elastic force of an elastic member, and the movable body is moved by rotating the rotary member.

In the aforementioned movable body driving device, a clutch means for allowing or interrupting the transmission of the rotational torque of the driving means to the rotary member is arranged between the rotary member and the driving means.

Further, in the aforementioned movable body driving device, the supporting member comprises a first supporting member for supporting the rotary member and a second supporting member for supporting the first supporting member via the elastic member, the first supporting member is biased toward the movable body by the elastic member and the second supporting member is fixed to a fixed side.

Further, in the aforementioned movable body driving device, the first supporting member is supported on the second supporting member in such a manner as to allow linear movement of the first supporting member relative to the second supporting member and is biased by the elastic member in such a direction that the first supporting member approaches the movable body.

Further, in the aforementioned movable body driving device, the first supporting member is swingably supported on the second supporting member via a supporting shaft and is biased by the elastic member in such a direction that the fee end thereof approaches the movable body.

Further, in the aforementioned movable body driving device, the rotary member is a roller and is in contact with the movable body to move the movable body by frictional force between the roller and the movable body.

Further, in the aforementioned movable body driving device, at least surface of the roller is made of a synthetic resin material. As at least the surface of the roller is made of a synthetic resin material and suitable synthetic resin (for example, urethane resin) is used as the synthetic resin material, suitable frictional force is generated in connection with the movable body.

Further, in the aforementioned movable body driving device, the movable body is provided with an engaging member with which the rotary member is engaged.

Further, in the aforementioned movable body driving device, the rotary member is a roller and the engaging member is a backing member which generates frictional force in connection with the roller.

Further, in the aforementioned movable body driving device, the rotary member is a pinion and the engaging member is a rack which can engages the pinion.

To achieve the aforementioned second object, the present invention provides automatic (electric) drawer equipment comprising a drawer which can be opened and closed relative to a frame body and a drawer driving mechanism for moving the drawer in an opening direction and a closing direction.

In the aforementioned automatic drawer equipment, the drawer driving mechanism comprises a rotary member rotatably supported on a supporting member and a driving means for rotating the rotary member, wherein the rotary member is engaged with the drawer with predetermined force using elastic force of an elastic member and the drawer is moved in the opening direction and the closing direction by rotating the rotary member.

In the aforementioned automatic drawer equipment, a clutch means for allowing or interrupting the transmission of the rotational torque of the driving means to the rotary member is arranged between the rotary member and the driving means.

Further, in the aforementioned automatic drawer equipment, the supporting member comprises a first supporting member for supporting the rotary member and a second supporting member for supporting the first supporting member via the elastic member, the first supporting member is biased toward the drawer by the elastic member, and the second supporting member is fixed to the frame body.

Further, in the aforementioned automatic drawer equipment, the first supporting member is supported on the second supporting member in such a manner as to allow linear movement of the first supporting member relative to the second supporting member and is biased by the elastic member in such a direction that the first supporting member approaches the drawer.

Further, in the aforementioned automatic drawer equipment, the first supporting member is swingably supported on the second supporting member via a supporting shaft and is biased by the elastic member in such a direction that the fee end thereof approaches the drawer.

Further, in the aforementioned automatic drawer equipment, the rotary member is a roller and is in contact with the drawer to move the drawer by frictional force between the roller and the drawer.

Further, in the aforementioned automatic drawer equipment, at least surface of the roller is made of a synthetic resin material.

Further, in the aforementioned automatic drawer equipment, a backing member for generating frictional force in connection with the roller is attached to a surface of the drawer with which the roller comes in contact.

### BEST MODE FOR CARRYING OUT THE INVENTION

Hereinafter, embodiments of the present invention will be described with reference to the attached drawings. Though the embodiments will be described with regard to cases of automatic drawer equipment and automatic door system, the movable body driving device according to the present Invention is not limited to those and can be adapted to a system for moving any of general movable bodies. FIGS. 1A-1C show the arrangement of a movable body driving device according to the present invention, wherein FIG. 1A is a plan view, FIG. 1B is a sectional view taken along an arrow B-B of FIG. 1A, and FIG. 1C is a frontal sectional view.

The movable body driving device 10 comprises a roller 12, as a rotary member supported by an inner frame 11 as a first supporting member in such a manner that the roller 12 is rotatable about a shaft 12a, and a motor 13. The rotational torque of the motor 13 is transmitted to the roller 12 via a motor gear 14 and an intermediate gear 15. That is, the motor 13, the motor gear 14, and the intermediate gear 15 compose a driving means for rotating the roller 12. The roller 12 is made of a synthetic resin (here, urethane resin). Numerals 18, 19, and 20 designate guide pins of which one ends are fixed to an outer frame 24 as a second supporting member. The other ends of the guide pins 18, 19, and 20 are inserted in guide-pin through holes formed in three wing portions 11a, 11b, and 11c formed on both ends and a side of the inner frame 11. Arranged about the outer peripheries of the guide pins 18, 19, 20 between the bottom surfaces of the wing portions 11a, 11b, and 11c and the surface of inner bottom of the outer frame 24 are coil springs (compression springs) 21, 22, 23 as elastic members, respectively.

A part of the outer periphery of the roller 12 protrudes from the upper surface of the inner frame 11 for a certain amount. As shown in FIG. 2, as the roller is pressed by, for example, a backing member 35 fixed to a bottom plate 36 of a drawer, the respective coil springs 21, 22, 23 are compressed so that the inner frame 11 is lowered in the outer frame 24. That is, the inner frame 11 is supported on the outer frame 24 in such a manner that the inner frame 11 can freely linearly move via the guide pins 18, 19, 20 and the coil springs 21, 22, 23. Numeral 17 designates a stopper ring for preventing each wing portion 11a, 11b, 11c of the inner frame 11 from coming off each guide pin 18, 19, 20.

FIG. 3 and FIGS. 4A-4B show a structural example of automatic drawer equipment in which the aforementioned movable body driving device is installed to drawer equipment. FIG. 3 is a partially cutaway view showing the entire arrangement of the drawer equipment and FIGS. 4A, 4B are illustrations showing a portion where the movable body driving device is installed. As shown in these drawings, the drawer equipment 30 has a plurality of drawers (three drawers in FIG. 3) vertically arranged. The movable body driving device 10 according to the present invention is installed as a drawer driving mechanism to a front end portion of a bottom frame plate 33 on which the lower most drawer 31 is placed.

A concavity 34 for installing the movable body driving device 10 is formed in the front end portion of the bottom frame plate 33. The outer frame 24 of the movable body driving device 10 having the aforementioned arrangement is fitted in the concavity 34 and is fixed to the bottom frame plate 33 by screws or the like (not shown). In this state, the roller 12 of the movable body driving device 10 is pressed by the backing member 35 attached to the lower surface of the bottom plate 36 of the drawer 31 so that the movable body driving device 10 becomes to a state shown in FIG. 2. As the motor 13 of the movable body driving device 10 is driven from this state, the drawer 31 moves forward by fraction generated between the roller 12 and the backing member 35 so that the drawer 31 becomes to a state shown in FIG. 5. In this case, the drawer 31 has a projecting portion 31a on the rear end thereof so that the lower surface of the projecting portion 31a extends at the same level as the lower surface of the bottom plate 36 (see FIG. 4A). The backing member 35 is also attached to the lower surface of the projecting portion 31a so that the drawer 31 can move to such a position as to facilitate the taking out of things from the drawer. As shown in FIG. 4B, a backing member 35 which is integrally formed with the projecting portion 31a may be attached to the bottom plate 36. Since the roller 12 has no fixed contact, the automatic drawer device 30 can be adapted to a detachable drawer as shown in FIG. 6. The backing member 35 is not necessarily required when sufficient frictional force between the drawer and the roller 12 can be obtained or when wear of the drawer due to the contact by the roller 12 does not cause a problem.

In the movable body driving device of this embodiment, the inner frame 11 is pushed up by biasing force of the coil springs 21, 22, 23 so as to press the roller 12 against the backing member 35 attached to the lower surface of the bottom plate 36 of the drawer 31. According to this arrangement, error in bottom level of the drawer in the vertical direction is absorbed by the function of the coil springs 21, 22, 23, thereby securely pressing the roller 12 against the bottom surface of the drawer 31 to generate frictional force between the roller 12 and the backing member 35 for power transmission. Particularly, the movable body driving device 10 is suitably used for detachable drawers because the detachable drawers are easily subjected to error in bottom level in the vertical direction as compared to fixed-type drawers. Further, even in case where heavy articles are accommodated in the drawer 31 so that the bottom plate 36 of the drawer 31 is deflected, displacement due to the deflection can be absorbed by the function of the coil springs 21, 22, 23 so as to ensure suitable frictional force between the roller 12 and the backing member 35, thereby allowing the movement of the drawer 31 in the opening direction and the closing direction.

FIG. 7 is a perspective view showing another embodiment of a movable body driving device according to the present invention. This movable body driving device 40 comprises a plate-like outer frame 41 as a second supporting member having an opening 42 formed in a central portion thereof such that a roller 12 protrudes a certain amount through the opening 42. One side portion of the outer frame 41 is cut out at two locations with a certain distance therebetween and the cut-out portions are bent downward to form pivot shaft supporting portion 41a, 41b. The pivot shaft supporting portions 41a, 41b support an inner frame 46 as a first supporting member such that the inner frame 46 can pivot about a pivot shaft 44 and allow springs 45, 45 (in the drawing, only one of the springs 45 is shown ) to be mounted to the both ends of the pivot shaft 44.

Similarly to the inner frame 11 shown in FIGS. 1A-1C, in the inner frame 46, a roller 12, an intermediate gear 15, and a motor gear 14 are rotatably arranged. As mentioned above, the inner frame 46 is pivotally supported on the outer frame 41 by the pivot shaft 44 and is biased by the elastic force of the springs 45, 45 about the pivot shaft 44 in such a direction as to protrude the roller 12 through the opening 42.That is, the inner frame 46 is swingably supported on the outer frame 41 via the pivot shaft 44 and the springs 45, 45 and is biased by the elastic force of the springs 45, 45 in such a direction as to protrude the free end side thereof through the opening 42. Also in the movable body driving device 40 of this arrangement, similarly to the above case, the pivot shaft supporting portions 41a, 41b and the inner frame 46 are accommodated in the concavity 34 formed in the front end portion of the bottom frame plate 33 and the outer frame 41 is fixed to the bottom frame plate 33, whereby the free end side of the inner frame 46 is biased by the elastic force of the springs 45, 45 in such a direction closing to the bottom plate 36, thereby constructing automatic drawer equipment.

Though any of the aforementioned embodiments has been described about an arrangement in which the roller 12 of the movable body driving device 10, 40 as the drawer driving mechanism is pressed against the bottom plate 36 of the drawer 31, an arrangement in which the roller is pressed against a side surface of a side wall of the drawer may be employed.

Instead of the roller 12 as a rotary member of the movable body driving device 10 shown in FIGS. 1A-1C for the arrangement of the drawer driving mechanism, a pinion 60 may be provided as shown in FIG. 8A such that the pinion 60 is driven by the motor 13 via the motor gear 14 and the intermediate gear 15. In addition, a rack 61 which can mesh with the pinion 60 may be provided on the lower surface of the bottom plate 36 as shown in FIG. 8B. Of course, also in the movable body driving device 40 having the arrangement shown in FIG. 7, a pinion may be used instead of the roller 12.

FIG. 9 through FIG. 11 show another embodiment of a movable body driving device, FIG. 9 is a plan view, FIG. 10 is a sectional view as seen in a direction of arrows A-A of FIG. 9, and FIG. 11 is a sectional view as seen in a direction of arrows B-B of FIG. 9. The movable body driving device 70 comprises a motor 13, a clutch mechanism 71 for transmitting the rotational torque of the motor 13, and a roller supporting mechanism 72 for supporting a roller 12 with predetermined elastic force in such a manner as to allow the roller 12 to move (swing) vertically. The motor 13 is a geared motor which is adapted not to rotate unless it is energized. The motor 13 is fixed to a bottom of a concavity 73a of a frame 73 via a bracket 74. Fixed to one end of the rotary shaft of the motor 13 is a motor gear 14.

The clutch mechanism 71 is located between the motor 13 and the roller supporting mechanism 72 and has a function of transmitting the rotational torque of the motor 13 to the roller 12 which is rotatably supported by a swing member 85 of the roller supporting mechanism 72. The clutch mechanism 71 comprises an intermediate gear 75 and a clutch 76. The intermediate gear 75 is rotatably supported on the bracket 74 by a rotary shaft 77 so as to mesh with the motor gear 14. The clutch 76 is rotatably supported on the bracket 74 by a rotary shaft 78. Fixed to one end of the rotary shaft 78 is an intermediate gear 79 so that the rotational torque of the intermediate gear 79 is transmitted to a gear 82, fixed to a shaft 12a of the roller 12, via a gear 80 and a gear 81.

In the roller supporting mechanism 72, a gear 80 is fixed to one end of a swing shaft (pivot shaft) 84 which is rotatably supported on a supporting member 83 fixed to the bottom of the concavity 73a of the frame 73.The swing member 85 is rotatably attached to the both ends of the swing shaft 84. The swing member 85 comprises the swing shaft 84, a rotary shaft 86 of the gear 81, gear supporting portions 85a, 85b rotatably supporting the both ends of the shaft 12a of the roller 12, and a coil spring receiving portion 85c to which ends of coil springs 87 are fixed. The gear supporting portions 85a, 85b are disposed opposite to each other and in parallel with each other and the coil spring receiving portion 85c is integrally formed on one ends of the gear supporting portions 85a, 85b to connect these to each other. One ends of a plurality of coil springs 87 are fixed to the coil spring receiving portion 85c of the swing member 85 and the other ends of the coil springs 87 are fixed to the bottom of the concavity 73a of the frame 73.

As the movable body driving device 70 having the aforementioned arrangement is mounted in the concavity 34 of the bottom frame plate 33 as shown in FIG. 10 and FIG. 11, the swing member 85 is pulled by the elastic force of the coil springs 87 so as to bias the roller 12 to move about the swing shaft 84 in a direction toward the bottom plate 36, thereby bringing the roller 12 into contact with the backing member 35 attached to the lower surface of the bottom plate 36 with the elastic force of the coil springs 87. The swing member 85 composes a first supporting member for rotatably supporting the roller 12 as the rotary member. The supporting member 83, which supports the swing member 85 so as to allow vertical swing motion of the swing member 85 via the coil springs 87, and the frame 73 compose a second supporting member.

In the movable body driving device 70 having the arrangement shown in FIG. 9 through FIG. 11, the motor 13 is a geared motor as mentioned above and is adapted not to rotate unless it is energized as mentioned above. That is, when the motor 13 is not energized or in a situation such as power outage where it is impossible to energize the motor 13, the roller 12 is in the locked state so that it is impossible to manually open the drawer. To solve this problem, the clutch mechanism 71 provided with the clutch 76 is arranged between the motor 13 and the roller supporting mechanism 72. When the clutch 76 is energized, the intermediate gear 75 is connected to the rotary shaft 78 via the clutch 76 so that the rotational torque of the intermediate gear 75 is transmitted to the rotary shaft 78. On the other hand, when not energized, the connection between the intermediate gear 75 and the rotary shaft 78 is cancelled so that the rotary shaft 78 is free to rotate. By simultaneously energizing the motor 13 and the clutch 76 via a cable 88 and simultaneously interrupting the energization, the drawer 31 can be manually opened smoothly when the motor 13 is not energized because the rotary shaft 78 becomes free to rotate and the roller 12 also becomes free to rotate.

Though any of the aforementioned embodiments has been described with regard to the case that the movable body driving device 10, 40, 10 having the arrangement shown in FIGS. 1A-1C, FIG. 7, FIGS. 8A-8B, or FIG. 9 through FIG. 11 is employed as the drawer driving mechanism, the drawer driving mechanism is not limited thereto. For example, a drawer driving mechanism of a linear motor type in which a reaction panel as the secondary side of a linear motor is attached to a drawer and the primary side is attached to a device frame, a drawer driving mechanism of a reacher type in which the drawer is opened by an electric reacher, and a drawer driving mechanism of sheave-&-belt type in which an electrical driving sheave and a belt are used may be employed. In the movable body driving devices 10, 40, 10, 70 shown in FIGS. 1A-1C, FIG. 7, FIGS. 8A-8B, and FIG. 9 through FIG. 11, the motor 13 may be an electric motor or a hydraulic motor.

Though any of the aforementioned embodiments has been described with regard to the cases that the movable body driving device 10, 40, 70 according to the present invention is employed as a driving mechanism of automatic (motor-driven) drawer equipment, the application of the movable body driving device 10, 40, 70 is not limited thereto. For example, as shown in FIGS. 12A-12B, the movable body driving device 10, 40 may be employed as a door driving device for opening and closing circular sliding doors 52, 52 for opening and closing an opening 51 of an entrance 50 protruding into a half cylindrical shape. FIG. 11A is a perspective view of the entrance of a building and FIG. 11B is a plan view showing a contact portion of the circular sliding door 52 with the roller 12 of the movable body driving device 10, 40, or 70.

Instead of the roller 12 as the rotary member of the movable body driving device 10 having the arrangement shown in FIGS. 1A-1C, a pinion 60 is used as shown in FIG. 8A and is adapted to be driven by the motor 13 via the motor gear 14 and the intermediate gear 15. Further, a rack 61 capable of meshing with the pinion 60 may be attached to a movable body 62 such as a drawer or a sliding door as shown in FIG. 10B. Of course, also in the movable body driving devices 10 having the arrangements shown in FIG. 7 and FIG. 1 through FIG. 10, a pinion may be used instead of the roller 12.

In the movable body driving devices 10, 40, 70, 10 shown in FIGS. 1A-1C, FIG. 7, FIG. 1 through FIG. 10, and FIGS. 12A-12B, the motor 13 may be an electric motor or a hydraulic motor.

Though the embodiments of the present invention are described in the above, the present invention is not limited to the aforementioned embodiments and various modifications may be made without departing from the scope in technical idea as defined in the appended claims, the specification, and the drawings.

### INDUSTRIAL APPLICABILITY

As described in the above, according to the movable body driving device according to the present invention, the rotary member is engaged with the movable body by a predetermined force using elastic force of the elastic member, whereby error in the mounting positions of the movable body and the rotary member is absorbed by the displacement of the elastic member so that the movable body and the rotary member are always suitably engaged with each other. Therefore, only quite easy adjustment for the engagement is required.

The clutch means for allowing or interrupting the transmission of the rotational torque of the driving means to the rotary member is arranged between the rotary member and the driving means, whereby even when a motor such as a geared motor which does not rotate unless it is energized is used as the driving source of the driving means and when the motor is not energized or in a situation such as power outage where it is impossible to energize the motor, the connection between the rotary member and the driving means is cancelled by the clutch means so that the rotary member becomes free to rotate so as to allow a user to manually move the movable body smoothly.

Further, since the first supporting member is supported on the second supporting member via the elastic member and is biased toward the movable body by the elastic member, the rotary member is suitably engaged with the movable body just by fixing the second supporting member to a predetermined position of the fixed side. Therefore, only quite easy adjustment for the engagement is required.

Further, since the first supporting member is supported on the second supporting member in such a manner as to allow linear movement of the first supporting member relative to the second supporting member and is biased by the elastic member in such a direction that the first supporting member approaches the movable body, similarly to the above case, the rotary member is suitably engaged with the movable body just by fixing the second supporting member to a predetermined position of the fixed side. Therefore, only quite easy adjustment for the engagement is required.

Further, since the first supporting member is swingably supported on the second supporting member via a supporting shaft and is biased by the elastic member in such a direction that the fee end thereof approaches the movable body, similarly to the invention claimed in claim 2, the rotary member is suitably engaged with the movable body just by fixing the second supporting member to a predetermined position of the fixed side. Therefore, only quite easy adjustment for the engagement is required.

Further, since the rotary member is a roller and is in contact with the movable body to move the movable body by frictional force between the roller and the movable body, the frictional force between the roller and the movable body can be adjusted by adjusting the force pressing the roller to the movable body by the elastic force of the elastic member. Therefore, the movable body can be moved by suitable driving force with the simple structure. Even when the surface of the movable body with which the roller comes in contact is uneven or sagging, the roller is always pressed against the movable body with suitable pressure because the displacement due to the unevenness and the sagging can be absorbed by the function of the elastic member. Therefore, suitable frictional force is always generated between the movable body and the roller so as to move the movable body.

According to the automatic drawer equipment according to the present invention, the drawer can be opened and closed by the drawer driving mechanism. Therefore, even when a user has something with his or her both hands, the user can open and close the drawer by operating (pressing, touching, or the like) an operation member with his or her foot or the like.

Further, the rotary member is engaged with the drawer with predetermined force using elastic force of the elastic member, error in the mounting positions of the drawer and the rotary member is absorbed by the displacement of the elastic member so that the drawer and the rotary member are always suitably engaged with each other. Therefore, only quite easy adjustment for the engagement is required.

The clutch means for allowing or interrupting the transmission of the rotational torque of the driving means to the rotary member is arranged between the rotary member and the driving means, whereby even when a motor such as a geared motor which does not rotate unless it is energized is used as the driving source of the driving means, the connection between the rotary member and the driving means is cancelled by the clutch means so that the rotary member becomes free to rotate so as to allow a user to manually move the drawer smoothly.

Further, since the first supporting member is supported on the second supporting member via the elastic member and is biased toward the drawer by the elastic member, the rotary member is suitably engaged with the drawer just by fixing the second supporting member to a predetermined position of the frame body (fixed side) Therefore, only quite easy adjustment for the engagement is required.

Further, since the first supporting member is supported on the second supporting member in such a manner as to allow linear movement of the first supporting member relative to the second supporting member and is biased by the elastic member in such a direction that the first supporting member approaches the drawer, similarly to the above case, the rotary member is suitably engaged with the drawer just by fixing the second supporting member to a predetermined position of the frame body. Therefore, only quite easy adjustment for the engagement is required.

Further, since the first supporting member is swingably supported on the second supporting member via a supporting shaft and is biased by the elastic member in such a direction that the fee end thereof approaches the drawer, similarly to the above case, the rotary member is suitably engaged with the drawer just by fixing the second supporting member to a predetermined position of the frame body. Therefore, only quite easy adjustment for the engagement is required.

Further, since the rotary member is a roller and is in contact with the drawer to move the drawer by frictional force between the roller and the drawer, the frictional force between the roller and the drawer can be adjusted by adjusting the force pressing the roller to the drawer by the elastic force of the elastic member. Therefore, the drawer can be moved by suitable driving force with the simple structure. Especially when the roller is in contact with the lower surface of the drawer bottom plate, the frictional force between the roller and the drawer depends on the weight of items accommodated in the drawer, that is, the force of pressing the roller by the drawer increases so that the frictional force also increases as the weight of items increases while the force of pressing the roller by the drawer decreases so the frictional force decreases as the weight of items decreases. Accordingly, the drawer can be opened and closed with suitable driving force. By the way, the drawer bottom plate may be deformed when heavy item(s) is accommodated in the drawer. Even when the bottom plate is deformed, the displacement due to the deformation can be absorbed by the function of the elastic member, whereby the roller is suitably in contact with the lower surface of the drawer bottom plate with suitable pressure.

Further, since at least surface of the roller is made of a synthetic resin material, suitable frictional force can be generated between the roller and the drawer by selecting suitable synthetic resin according to the material constructing the drawer.

Further, since the backing member for generating frictional force in connection with the roller is attached to the surface of the drawer with which the roller comes in contact, suitable frictional force can be generated between the roller and the drawer by selecting suitable material for the backing member according to the material forming the roller surface and wear of the surface of the drawer with which the roller comes in contact can be prevented.

### BRIEF DESCRIPTION OF THE DRAWINGS

FIGS. 1A-1C are illustrations showing an embodiment of a movable body driving device according to the present invention;

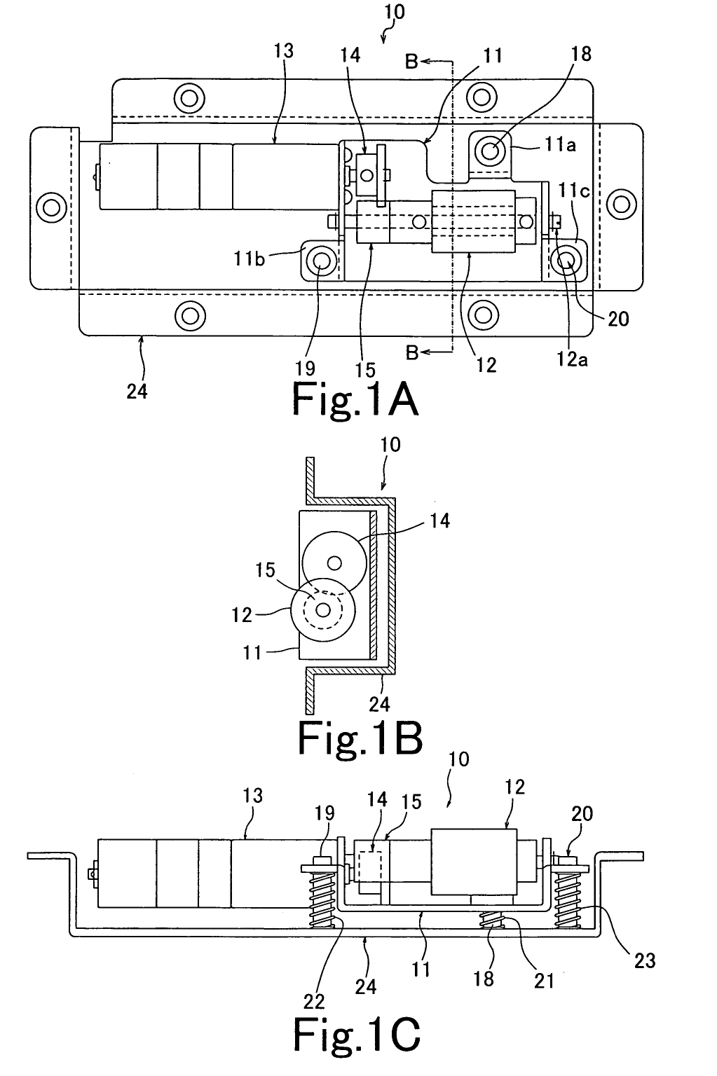

FIG. 2 is an illustration showing the movable body driving device according to the present invention in a state that a bottom plate of a drawer is placed over the movable body driving device;

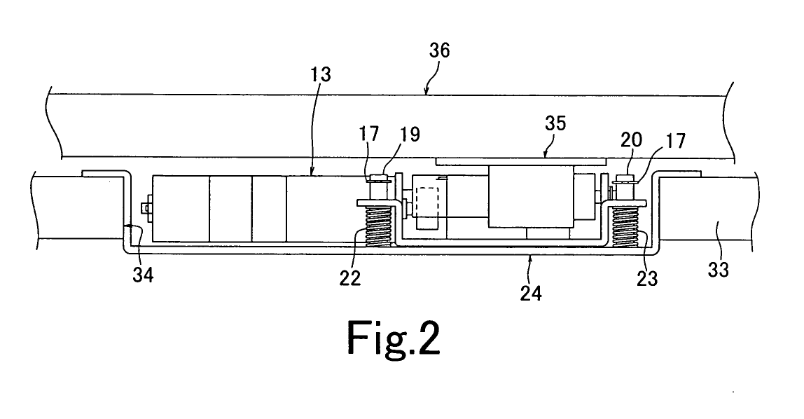

FIG. 3 is an illustration showing an embodiment of electric drawer equipment equipped with the movable body driving device according to the present invention;

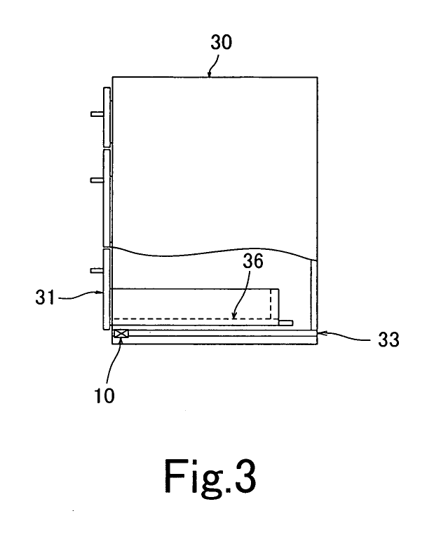

FIGS. 4A, 4B are illustrations showing a portion of the electric drawer equipment where the movable body driving device is mounted;

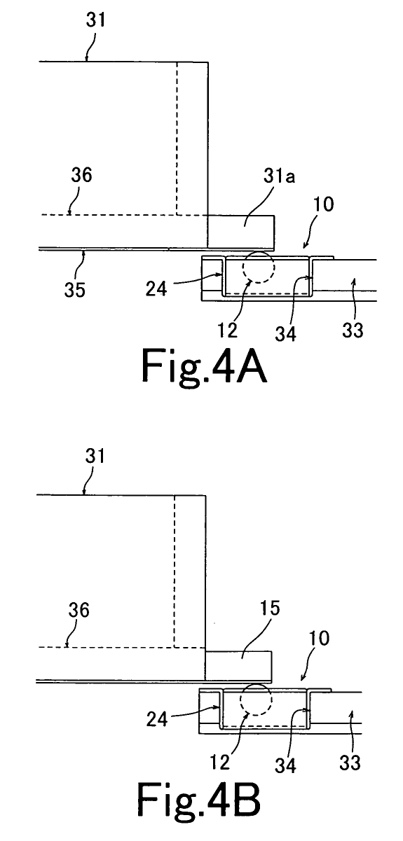

FIG. 5 is an illustration showing the electric drawer equipment shown in FIG. 3 in a state that the lowermost drawer is opened;

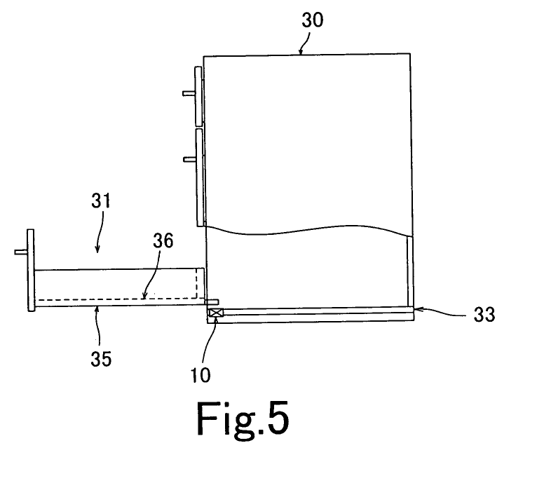

FIG. 6 is an illustration showing the electric drawer equipment shown in FIG. 3 in a state that the lowermost drawer is detached;

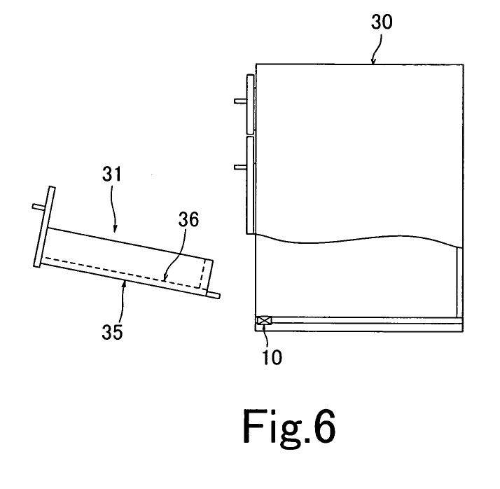

FIG. 7 is an illustration showing an embodiment of the movable body driving device according to the present invention;

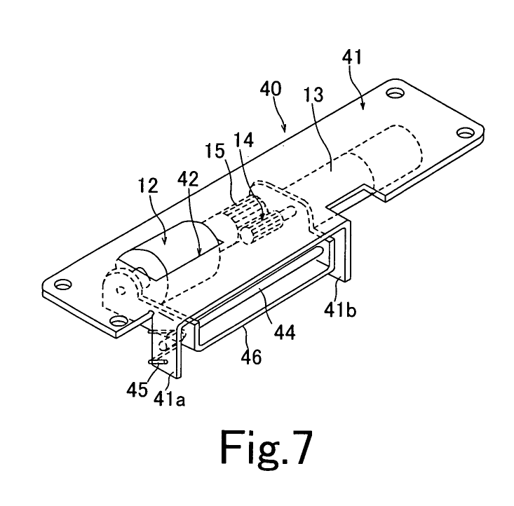

FIGS. 8A, 8B are illustrations showing an embodiment of the movable body driving device according to the present invention;

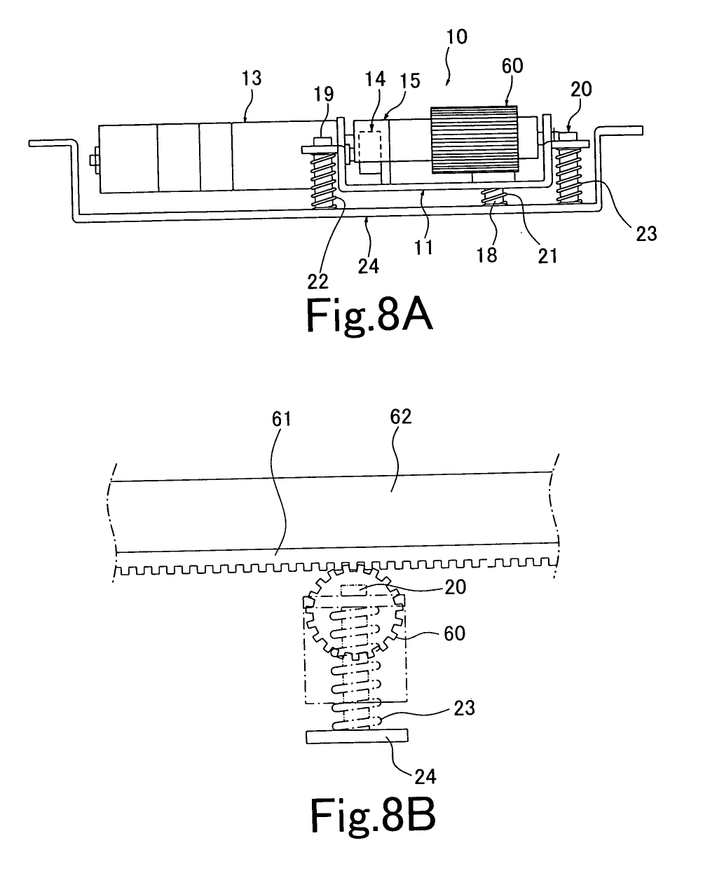

FIG. 9 is an illustration showing an embodiment of the movable body driving device according to the present invention;

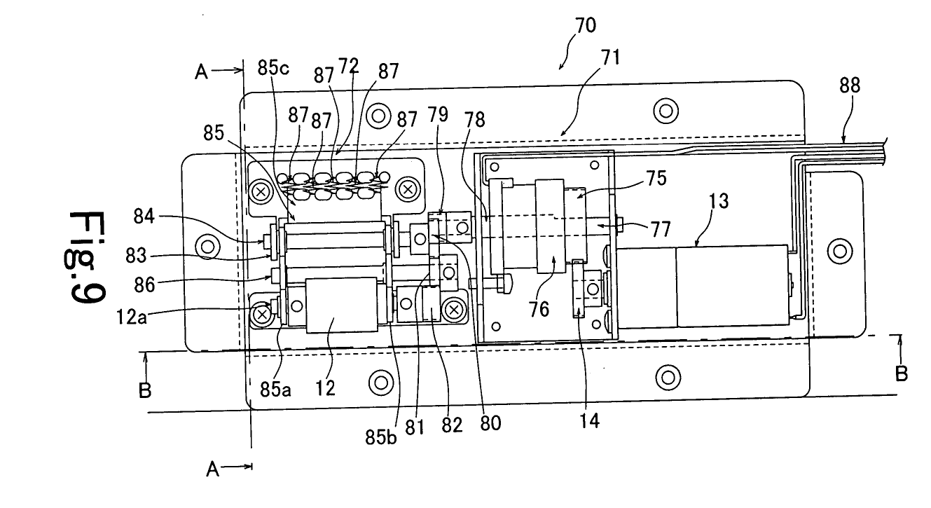

FIG. 10 is a sectional view as seen in a direction of arrows A-A of FIG. 9;

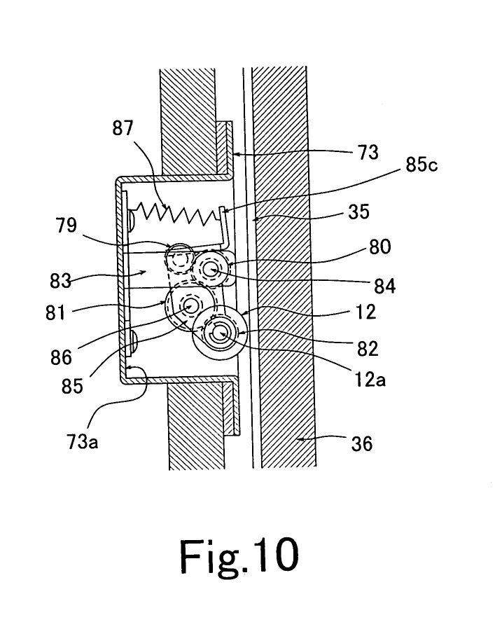

FIG. 11 is a sectional view as seen in a direction of arrows B-B of FIG. 9; and

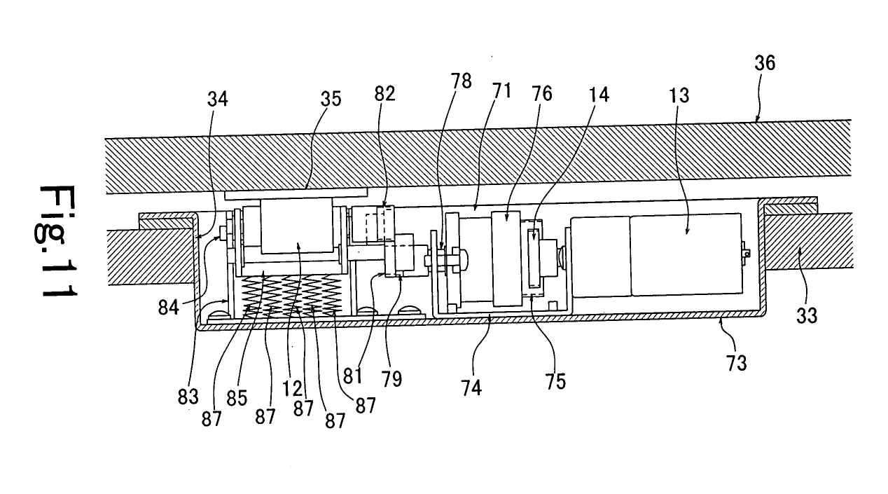

FIGS. 12A, 12B are illustrations showing an example that the movable body driving device according to the present invention is used as a driving device for a circular sliding door.

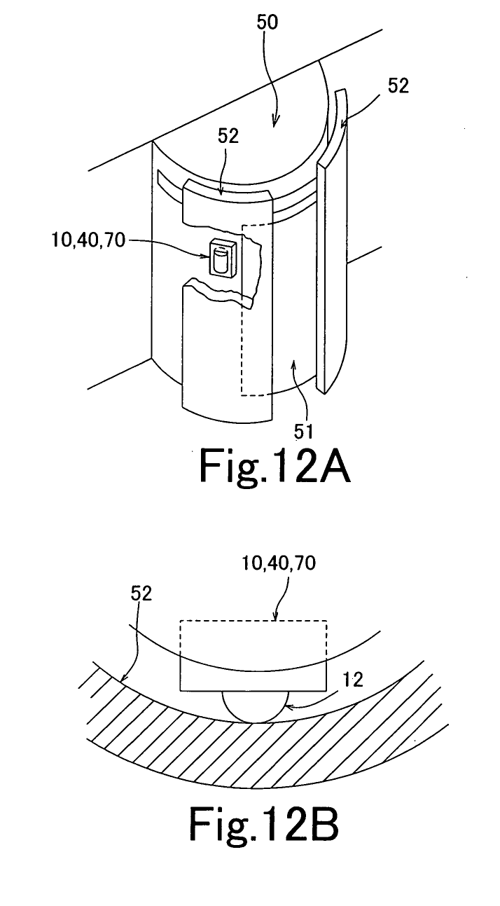

### EXPLANATION OF REFERENCE SIGNS

10 movable body driving device
11 inner frame
12 roller
13 motor
14 motor gear
15 intermediate gear
17 stopper ring
18 guide pin
19 guide pin
20 guide pin
21 coil spring
22 coil spring
23 coil spring
24 outer frame
30 drawer equipment
31 drawer
33 bottom frame plate
34 concavity
35 backing member
36 bottom plate
40 movable body driving device
41 outer frame
42 opening
44 pivot shaft
45 spring
46 inner frame
50 entrance
51 opening
52 sliding door
60 pinion
61 rack
62 movable body
70 movable body driving mechanism
71 clutch mechanism
72 roller supporting mechanism
73 frame
74 bracket
75 intermediate gear
76 clutch
77 rotary shaft
78 rotary shaft
79 intermediate gear
80 gear
81 gear
82 gear
83 supporting member
84 swing shaft
85 swing member
86 rotary shaft
87 coil spring

1. A movable body driving device including a movable body which is adapted to be movable in a certain direction and a driving mechanism, said driving mechanism comprising a rotary member rotatably supported on a first supporting member, a driving means for rotating said rotary member, a second supporting member which is fixed to a fixed side, and an elastic member which is arranged between said first supporting member and said second supporting member,
wherein said rotary member of said driving mechanism is engaged with said movable body with predetermined force using elastic force of said elastic member and said movable body is moved by rotating said rotary member.

2. A movable body driving device as claimed in claim 1, wherein a clutch means for allowing or interrupting the transmission of the driving force of said driving means to said rotary member is arranged between said rotary member and said driving means.

3. (canceled)

4. A movable body driving device as claimed in claim 1 or 2, wherein said first supporting member is supported on said second supporting member in such a manner as to allow linear movement of said first supporting member relative to said second supporting member and is biased by said elastic member in such a direction that said first supporting member approaches said movable body.

5. A movable body driving device as claimed in claim 1 or 2, wherein said first supporting member is swingably supported on said second supporting member via a supporting shaft and is biased by said elastic member in such a direction that the fee end thereof approaches said movable body.

6. A movable body driving device as claimed in claim 1 or 2, wherein said rotary member is a roller and is in contact with said movable body to move said movable body by frictional force between said roller and said movable body.

7. Automatic drawer equipment including a drawer which can be opened and closed relative to a frame body and a drawer driving mechanism, said drawer driving mechanism comprising a rotary member rotatably supported on a first supporting member, a driving means for rotating said rotary member, a second supporting member which is fixed to said frame body, and an elastic member which is arranged between said first supporting member and said second supporting member,
wherein said rotary member of said drawer driving mechanism is engaged with a lower surface of said drawer with predetermined force using elastic force of said elastic member and said rotary member is rotated by said driving means to move said drawer in an opening direction and a closing direction so that said drawer is opened and closed.

8. (canceled)

9. Automatic drawer equipment as claimed in claim 7, wherein a clutch means for allowing or interrupting the transmission of the driving force of said driving means to said rotary member is arranged between said rotary member and said driving means.

10. (canceled)

11. Automatic drawer equipment as claimed in claim 7 or 9, wherein said first supporting member is supported on said second supporting member in such a manner as to allow linear movement of said first supporting member relative to said second supporting member and is biased by said elastic member in such a direction that said first supporting member approaches said drawer.

12. Automatic drawer equipment as claimed in claim 7 or 9, wherein said first supporting member is swingably supported on said second supporting member via a supporting shaft and is biased by said elastic member in such a direction that the fee end thereof approaches said drawer.

13. Automatic drawer equipment as claimed in claim 7 or 9, wherein said rotary member is a roller and is in contact with said drawer to move said drawer by frictional force between said roller and said drawer.

14. Automatic drawer equipment as claimed in claim 13, wherein at least surface of said roller is made of a synthetic resin material.

15. Automatic drawer equipment as claimed in claim 13, wherein a backing member for generating frictional force in connection with said roller is attached to a surface of said drawer with which said roller comes in contact.
